(19) United States
(12) Patent Application Publication
(10) Pub. No.: US 2017/0362343 A1
(43) Pub. Date: Dec. 21, 2017

(54) USE OF DESTRUCTURED STARCH DERIVATIVES AS HYSTERESIS REDUCTION ADDITIVES FOR ELASTOMER COMPOSITIONS

(71) Applicant: NOVAMONT S P A., Novara (IL)

(72) Inventors: Catia BASTIOLI, Novara (IT); Luigi CAPUZZI, Novara (IT); Paolo MAGISTRAILI, Novara (IT); Sebastia GESTI' GARCIA, Torino (IT)

(21) Appl. No.: 15/537,439

(22) PCT Filed: Dec. 17, 2015
(86) PCT No.: PCT/EP2015/080231

§ 371 Date: Jun. 19, 2017

(30) Foreign Application Priority Data
Dec. 19, 2014 (IT) MI2014A002189

(51) Int. Cl. C08B 31/00; C08L 7/00; C08K 5/548; C08K 3/36; C08K 5/05; C08K 5/00; C08L 9/06; C08L 3/04

(52) U.S. Cl. CPC C08B 31/006; C08L 9/06; C08L 7/00; C08L 3/04; C08K 3/36; C08K 5/05; C08K 5/0025; C08K 5/0016; C08K 5/548

(57) ABSTRACT

This invention relates to the use of destructured starch derivatives as hysteresis reduction additive in elastomer compositions and elastomer compositions containing those derivatives.

This invention relates to the use of destructured starch derivatives as hysteresis reduction additives in elastomer compositions and elastomer compositions containing the said additives. Hitherto elastomers have constituted a type of polymers which has been widely used for the production of many manufactured articles, such as for example packaging, tyres, expanded products, anti-vibration devices, suspensions, non-slip mats, resilient components, footwear, insulating materials and sheathing for electrical cables, tubes for various applications, conveyor belts, which are characterised by the ability to deform when force is applied and to recover their original shape when the force is removed.

If subjected to repeated force/recovery cycles the elastomers nevertheless progressively tend to alter their behaviour, gradually losing their ability to fully recover their original shape. This phenomenon, known as hysteresis, results in a gradual loss of performance which limits the service life of the articles manufactured using them, in terms of both time and use. There is therefore a need to improve the performance of the elastomers and in particular to reduce their hysteresis phenomena so as to extend the service life of articles manufactured using these products.

In the sector of elastomer compositions it has been known for a long time that starch in a complexed or plasticised form can be used as a filler. Because of its ready availability and relatively low cost starch in fact appears to have the ideal characteristics for use as a filler, alone or in combination with for example carbon black, silica, kaolin, mica, talc or titanium oxide.

However, starch as available in nature (so-called native starch) has limited stability properties when exposed to thermal and mechanical stresses, which means that it cannot effectively be used as a filler. If added during the preparation of elastomer compositions native starch in fact undergoes degradation phenomena. Its granular structure also makes it difficult to disperse, creating non-uniform morphologies which will prejudice the performance of elastomer compositions containing it.

In order to overcome the limited stability and difficulty of dispersion of native starch in elastomer compositions it is known that starch can be used in a complexed or plasticised form with polymers such as poly(ethylenevinyl alcohol) or poly(ethyleneacrylic acid). For example U.S. Pat. No. 5,672,639 describes elastomer compositions comprising a low melting point composite comprising starch plasticised with a plasticising polymer (EVOH). According to U.S. '639, the use of a low melting point composite allows it to melt and mix properly during the stages of processing the elastomer composition.

It has now surprisingly been discovered that, thanks to its low viscosity and its ability to disperse uniformly in elastomers, it is possible to use from 3 to 70 parts per 100 parts of elastomer (phr), preferably from 3 to 50 and more preferably from 5 to 30, of destructured and crosslinked starch as hysteresis reduction additive in elastomer compositions, maintaining and ultimately improving the performance of already known starch-based fillers, in particular as regards hysteresis phenomena in the elastomer compositions.

This invention relates to compositions comprising:
i. at least one elastomer;
ii. from 3 to 70 phr, preferably from 3 to 50 and more preferably from 5 to 30, of destructured crosslinked starch according to this invention as hysteresis reduction additive.

For the purposes of this invention, by destructured starch is meant a starch of any kind which has substantially lost its native granular structure. As far as the native granular structure of starch is concerned, this can be advantageously identified by phase contrast optical microscopy. In one particularly preferred embodiment of this invention the destructured starch is a starch which has completely lost its native granular structure, also known as “completely destructured starch”.

The destructured crosslinked starch according to this invention can be obtained by means of a process in a single stage or in several stages.

A first method comprises preparing the destructured crosslinked starch in a single stage. In accordance with this method the starch is destructured and simultaneously mixed with at least one crosslinking agent. Alternatively preparation of the destructured crosslinked starch may take place in a process with several stages, in which the starch is first destructured and subsequently mixed with at least one crosslinking agent.

The starch which can be used for preparation of the destructured crosslinked starch according to this invention is preferably selected from native starch, such as for example maize, potato, rice and tapioca starch and physically or chemically modified starch, such as for example starch ethoxylate, starch acetate or starch hydroxypropylate, starch oxidate, dextrinised starch, dextrins and mixtures thereof. Preferably the starch used for preparation of the destructured crosslinked starch is native starch.

Destructuring of the starch is advantageously carried out in any of the items of equipment capable of ensuring the temperature, pressure and shear force conditions suitable for destroying the native granular structure of the starch. Suitable conditions for obtaining complete destructuring of the starch are for example described in patents EP-0 118 240 and EP-0 327 505. Advantageously, destructuring of the starch is carried out by means of an extrusion process at temperatures of between 110 and 250° C., preferably 130-180° C., and at pressures between 0.1 and 7 MPa, preferably 0.3-6 MPa, preferably providing a specific energy of more than 0.1 kWH/kg during this extrusion.

Destructuring of the starch preferably takes place in the presence of 1 to 40% by weight with respect to the weight of the starch of one or more plasticisers selected from water and polyols having 2 to 22 carbon atoms. As far as the water is concerned, this may also be that naturally present in the starch. Among the polyols, those preferred are polyols having from 1 to 20 hydroxyl groups containing 2 to 6 carbon atoms, their ethers, thioethers and organic and inorganic esters. Examples of polyols are glycerine, diglycerol, polyglycerol, pentaerythritol, polyglycerol ethoxylate, ethylene glycol, polyethylene glycol, 1,2-propandiol, 1,3-propandiol, 1,4-butandiol, neopentylglycol, sorbitol monoacetate, sorbitol diacetate, sorbitol monoethoxylate, sorbitol diethoxylate, and mixtures thereof. In a preferred embodiment the starch is destructured in the presence of glycerol or a mixture of plasticisers comprising glycerol, more preferably comprising between 2 and 90% by weight of glycerol. Preferably the destructured crosslinked starch according to this invention comprise between 1 and 40% by weight of plasticisers with respect to the weight of the starch.

During destructuring of the starch it is also preferable to add one or more starch depolymerising agents selected from organic acids, inorganic acids, for example sulfuric acid, and enzymes, preferably amylases. It has in fact surprisingly been discovered that the destructured crosslinked starch so obtained has a lower viscosity, and can thus be more readily dispersed in elastomers. Preferably the organic acids used as depolymerising agents are added to the starch in a quantity of 0.1-10% by weight with respect to the starch and are advantageously selected from citric acid, maleic acid, lactic acid, oxalic acid, gluconic acid and mixtures thereof, more preferably citric acid. As far as the inorganic acids are concerned, these are advantageously added in a quantity of 0.1-10% by weight with respect to the starch. Preferably the destructured crosslinked starch according to this invention comprises between 0.1 and 5% by weight of depolymerising agents with respect to the weight of the starch.

As far as the crosslinking agents are concerned, these are preferably selected from dialdehydes and polyaldehydes, anhydrides and mixtures thereof. As far as dialdehydes and polyaldehydes are concerned, those preferred are glutaraldehyde, glyoxal and their mixtures, of these glyoxal being particularly preferred. In a particularly preferred embodiment the destructured crosslinked starch according to this invention can be obtained in the presence of 0.1 to 5% by weight with respect to the weight of the starch of crosslinking agents, more preferably glyoxal. The said crosslinking agents are advantageously mixed with the starch at the temperature for preparation of the destructured starch. Preferably the destructured and crosslinked starch according to this invention comprises between 0.1 and 3% by weight with respect to the weight of the starch of one or more crosslinking agents.

During destructuring, or in the case of the method of preparation in several stages described above, dispersing agents, surfactants, anti-foaming agents, suspending agents, thickening agents and preservatives may also be added.

In a preferred embodiment the destructured crosslinked starch according to this invention can be obtained by extruding at least one starch in the presence of 1-40% by weight with respect to the weight of the starch of one or more plasticising agents preferably comprising at least 2-90% by weight of glycerol with respect to the total weight of the plasticising agents, and in the presence of 0.1-5% by weight with respect to the weight of the starch of at least one crosslinking agent, preferably glyoxal, at a temperature of between 110 and 250° C., preferably 130-180° C.

The crosslinking agent may also be added after destructuring of the starch. In another preferred embodiment the destructured crosslinked starch according to this invention can therefore be obtained by a process providing the stages of:
a. extruding at least one native starch in the presence of 1-40% by weight with respect to the weight of the native starch of one or more plasticising agents preferably comprising at least 2-90% by weight of glycerol with respect to the total weight of plasticising agents, at a temperature of between 110 and 250° C., preferably 130-180° C.,
b. causing the starch and the extruded plasticisers in stage a to react, preferably under the same conditions as in stage a, with 0.1-5% by weight with respect to the weight of the starch of at least one crosslinking agent, preferably glyoxal.

The destructured and crosslinked starch according to this invention is characterised by properties which make it particularly suitable for use as as hysteresis reduction additive in elastomer compositions. In particular the destructured crosslinked starch according to this invention demonstrates the ability to disperse in nanoparticles or agglomerates of nanoparticles.

This invention also relates to compositions comprising:
iii. at least one elastomer;
iv. from 3 to 70 phr, preferably from preferably from 3 to 50 and more preferably from 5 to 30 of at least one destructured starch derivative according to this invention as hysteresis reduction additive.

As far as the elastomers are concerned, these comprise both natural rubbers (NR) and synthetic rubbers. Examples of synthetic rubbers are diene-base rubbers such as conjugated vinylarene-diene random copolymers (e.g. SBR, Styrene/Butadiene Rubber) and diene homopolymers (e.g. polybutadiene, isoprene), ethylene-propylene copolymers, in particular ethylene/propylene/diene terpolymers (EPDM, Ethylene/Propylene/Diene Monomer), and thermoplastic elastomers such as for example styrene-butadiene-styrene (SBS), acrylonitrile-butadiene (NBR) and styrene-isoprene-styrene (SIS) block copolymers. These elastomers may be used as such or in a mixture with other elastomers.

In a preferred embodiment, compositions according to this invention comprise at least one elastomer selected from natural rubber, diene homopolymers, preferably polybutadiene and isoprene, styrene-butadiene-styrene block copolymers, styrene-isoprene random copolymers, styrene-isoprene-styrene block copolymers, acrylonitrile-butadiene block copolymers, and conjugated vinylarene-diene random copolymers.

In a preferred embodiment the compositions according to this invention comprise a mixture of elastomers comprising:
a. from 30 to 90% by weight with respect to the total of components i and ii of at least one conjugated vinylarene-diene random copolymer;
b. from 10 to 70% by weight with respect to the sum of components i and ii of at least one elastomer selected from natural rubber, diene homopolymers, preferably polybutadiene and isoprene, styrene-butadiene-styrene block copolymers, styrene-isoprene random copolymers, styrene-isoprene-styrene block copolymers or acrylonitrile-butadiene block copolymers.

Preferably the compositions according to this invention comprise from 3 to 70 phr, preferably preferably from 3 to 50 and more preferably from 5 to 30 of destructured crosslinked starch according to this invention as hysteresis reduction additive.

Typical examples of vinylarenes are 2-vinyl naphthalene, 1-vinyl-naphthalene, styrene and corresponding alkylated compounds. In the preferred embodiment the vinylarene is styrene. The conjugated dienes are preferably 1,3-dienes having from 4 to 12 carbon atoms, more preferably from 4 to 8 carbon atoms. Examples of these dienes are 1,3-butadiene, isoprene, 2,3-dimethyl-1,3 butadiene, 1,3 pentadiene (piperylene), 2-methyl-3-ethyl-1,3-butadiene, or 1,3-octadiene. In the preferred embodiment the conjugated dienes are selected from 1,3-butadiene and isoprene, more preferably 1,3-butadiene.

In a particularly preferred embodiment the conjugated vinylarene-diene random copolymers are styrene-butadiene random copolymers. In the rest of the description reference will be made to these copolymers as being typical examples of conjugated vinylarene-diene random copolymers, without however intending to limit the scope of the description to the specific copolymers.

By the term styrene-butadiene “random” copolymer in the meaning of this invention are meant copolymers in which the styrene content in the form of blocks is 10% or less in relation to the bound styrene, as measured by the oxidative decomposition method described by I. M. Kolthoff et al., J. Polymer Science, Vol. 1, page 429 (1946), or more recently Viola et al. (Sequence distribution of styrene-butadiene copolymers by ozonolysis, high performance liquid chromatographic and gas chromatographic-mass spectrometric techniques, J Chromatography A, 117 (1994)).

The abovementioned styrene-butadiene random copolymers have a styrene content of between 15 and 50% by weight, preferably between 20 and 50% by weight.

As is known, butadiene may be bound to the polymer chain through cis-1,4 bonds (cis bonds), trans-1,4 bonds (trans bonds) or as 1,2 bonds (vinyl bonds). The content of vinyl units is defined as the ratio between the quantity of vinyl bonds and the sum of cis, trans and vinyl bonds. The content of a vinyl unit of the diene portion of a styrene-butadiene random copolymer preferably lies between 10 and 80%. The abovementioned concentration in vinyl units may be distributed uniformly along the polymer chain, or may be increased or diminished along the chain.

The styrene-butadiene random copolymers may be obtained by any one of the processes known in the literature, preferably by means of two different processes—from solution or in emulsion.

As far as solution processes are concerned, these are preferably performed by anionic polymerisation initiated by lithium alkyls in hydrocarbon solvents. In this case the weight average molecular weight (Mw) which can be measured by exclusion chromatography is preferably between 50,000 and 1,000,000, with a distribution of the molecular weights (Mw/Mn) of between 1 and 10. Preferably Mw lies between 300,000 and 800,000 and Mw/Mn lies between 1 and 5, more preferably between 1 and 3. In the case of processes from solution the styrene-butadiene copolymers preferably have a styrene content of between 15 and 50% by weight, preferably between 20 and 45% by weight, while the content of vinyl units is preferably between 10 and 80% by weight, preferably between 20 and 70%. The molecular structure is linear or branched, the latter being obtained by reacting the active terminal groups with bonding agents such as silicon tetrachloride, tin tetrachloride or other multifunctional group bonding agents according to the known art at the end of the polymerisation. The Mooney viscosity of the polymer when not extended with ML(1+4) oil @ 100° C. preferably lies between 30 and 200 Mooney Units (MU), preferably between 50 and 150, while the corresponding polymer extended with extender oils has a Mooney viscosity at 100° C. within the range 30 to 120 MU. As regards the determination of Mooney viscosity, this is performed at 100° C. with rotor L and times (1+4) according to standard ASTM D1646. As far as processes in emulsion are concerned, these are preferably performed by free radical polymerisation. In this case, as is known, the structure of the copolymer obtained is branched because of transfer reactions on the molecular chain during the propagation stage. In the case of the styrene-butadiene copolymers obtained by means of processes in emulsion, the quantity of styrene is preferably between 20 and 50%, while the quantity of vinyl units is preferably between 15 and 25%. As is known, the vinyl units content in the styrene-butadiene copolymers can be adjusted during the free radical polymerisation processes of this kind by modulating the synthesis temperature. The Mooney viscosity of the polymer extended with extender oils, preferably has values within the range 30-120 MU at 100° C.

The compositions according to this invention may also include extender oils, fillers, reinforcing fillers, bonding agents, vulcanising agents, accelerants, activators, vulcanisation retardants, organic acids, antioxidants, process coadjuvants and other additives as known in the art.

Preferably the compositions according to this invention comprise 1-75 phr, more preferably 7-50 phr, even more preferably 10-40 phr of at least one extender oil. Preferably the extender oils are selected from vegetable oil derivatives, mineral oils and/or natural oils and mixtures thereof. As is known, extender oils can be added at different stages in preparation of the elastomer compositions. During preparation of the elastomer or during the stage of mixing the elastomer with other components (for example destructured crosslinked starch, fillers, reinforcing fillers, vulcanising agents, bonding agents), this latter stage is also known as the compounding stage.

According to one embodiment of this invention the extender oils are added during the stage of elastomer preparation. Preferably, in the case of elastomers obtained by anionic polymerisation in solution, the extender oil is added to the polymer solution, preferably followed by additives such as antioxidants. Advantageously, at the end of anionic polymerisation in solution the solvent is removed in stirred baths heated with steam. In the case of elastomers obtained by free radical polymerisation the extender oils may be advantageously added to the aqueous emulsion, preferably followed by additives in the normal way, and by the removal of solvent after coagulation through the addition of sulfuric acid.

The elastomer so obtained (commonly also referred to as “extended oil elastomer”) is therefore advantageously dried using mechanical extruders or heated stoves and subsequently formed into balls before the subsequent stages of processing.

According to another embodiment of this invention the extender oils are added to the elastomer composition during the compounding stage together with the other components such as for example destructured starch silyl ethers, vulcanising agents (e.g. sulfur) and accelerants, activators, vulcanisation retardants, organic acids, antioxidants, process coadjuvants and other additives as known in the art.

Obviously it is possible to combine the two embodiments described above by adding a proportion or a type of extender oils during the stage of preparing the elastomer and another portion or type during the compounding stage.

As far as the extender oils derived from vegetable oils are concerned, these are advantageously selected from:
A1) mixtures of triglycerides obtained from vegetable oils comprising one or more of the following oligomer structures:

R₄—[O—C(O)—R₁—C(O)—O—CH₂—CH(OR₂)—CH₂—]ₙ—O—R₃
in which
R₁ is selected from C₂-C₂₂ alkylenes,
R₂ is selected from one or more of the following groups formed from residues of C₆-C₂₄ dicarboxylic acids esterified with monoalcohols and C₆-C₂₄ monocarboxylic acid residues,
R₃ is selected from one or more of the following groups comprising H, C₆-C₂₄ dicarboxylic acid residues esterified with monoalcohols and C₆-C₂₄ monocarboxylic acid residues,
R₄ is an alkyl group,
n is a whole number greater than or equal to 2,
the said mixture of triglycerides having a number average molecular weight (Mn) of between 800 and 10,000 Da,
A2) triglycerides of one or more long chain carboxylic acids comprising at least one carboxylic acid containing vicinal hydroxide groups;
A3) polyol esters with at least one C₆-C₂₄ monocarboxylic acid and at least one C₆-C₂₄ dicarboxylic acid, the said esters not being triglycerides;

the said vegetable oil derivatives are preferably characterised by a mean molecular weight of less than 10,000 g/mol. The said vegetable oil derivatives also show high stability to thermo-oxidation and high stability to hydrolysis, and are thereby particularly suitable for use in compositions for high performance applications, such as for example tyres and elastomer articles resistant to very low temperatures.

With reference to group A1, R₁ is preferably a C₆-C₁₁ alkylene, C₆, C₇ and/or C₁₁ alkylenes being particularly preferred. The two or more R₁ in the structure may be different from each other.

Preferably, R₂ is selected from C₆-C₂₄ dicarboxylic acid residues and C₆-C₂₄ monocarboxylic acid residues or mixtures thereof. The two or more R₂ in the structure may be different from each other.

R₃ preferably represents C₆-C₂₄ dicarboxylic acid residues or C₆-C₂₄ monocarboxylic acid residues.

When R₂ and/or R₃ represent C₆-C₂₄ dicarboxylic acid residues, the free acid groups in the C₆-C₂₄ dicarboxylic acid residues are esterified with straight or branched C₁-C₁₂ monoalcohols. Short chain monoalcohols, such as for example methyl alcohol, ethyl alcohol, propyl alcohol and butyl alcohol are particularly preferred. Ethyl alcohol and butyl alcohol are particularly advantageous.

R₄ is preferably a straight or branched C₁-C₁₂ alkyl group, more preferably a C₂ or C₄ alkyl group.

In the case of group A1) of vegetable oil derivatives, by C₆-C₂₄ dicarboxylic acids are meant aliphatic diacids preferably of the alpha-omega type. Suberic acid, azelaic acid, brassylic acid and their mixtures are particularly preferred.

In the case of group A1) of vegetable oil derivatives, by C₆-C₂₄ monocarboxylic acids are meant mono acids having one or more unsaturations along the chain, and may be substituted or unsubstituted.

The preferred unsubstituted monocarboxylic acids are mono acids having a chain length of C₉₋₂₄; particularly preferred are palmitic, stearic, oleic, arachic, behenic and lignoceric acids.

The preferred substituted monocarboxylic acids are long chain monocarboxylic acids with one or more ketone groups or hydroxyl groups in a non-terminal position, and among these the C₁₂-C₂₄ carboxylic acids containing at least one ketone group or C₁₂-C₂₄ hydroxy acids containing at least one secondary hydroxyl group are particularly preferred. Examples of preferred substituted monocarboxylic acids are 9-hydroxystearic acid, 9-ketostearic acid, 10-ketostearic acid and 10-hydroxystearic acid.

The said substituted monocarboxylic acids may contain two adjacent hydroxyl groups or a hydroxyl group adjacent to a ketone group. If two adjacent hydroxyl groups are present, dihydroxypalmitic, dihydroxystearic, dihydroxyoleic, dihydroxyarachic and dihydroxybehenic acids are preferred; 9,10-dihydroxystearic acid is particularly preferred.

Advantageously, the oligomer structures according to the invention are dimer or trimer esters of triglycerides having a number of repetitive units (n) equal to 2 or 3.

Particularly preferred are dimers and trimers of triglycerides containing C₆-C₂₄ dicarboxylic acid residues. Examples of preferred dimer and trimer esters are illustrated by the following structures.

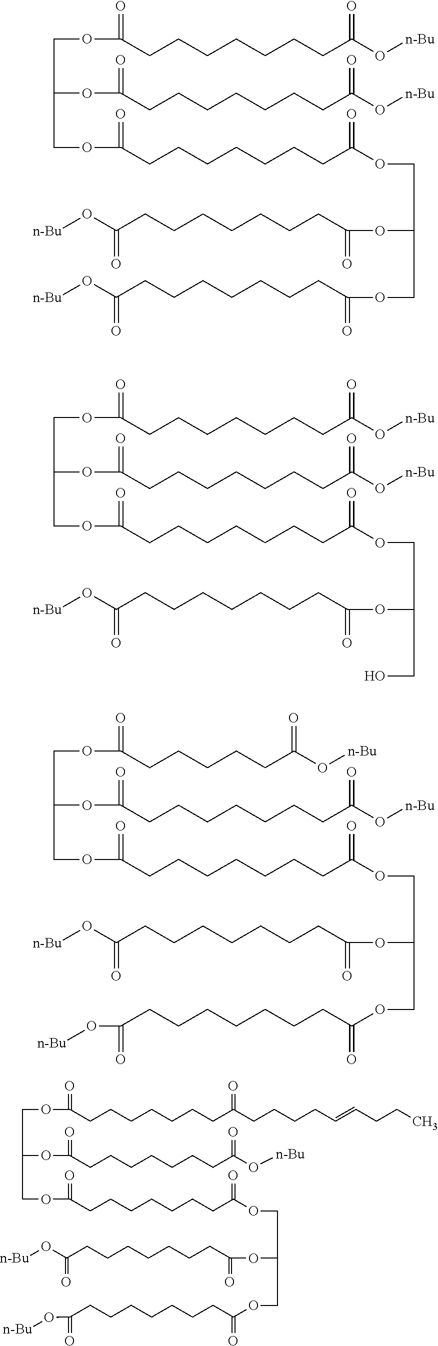

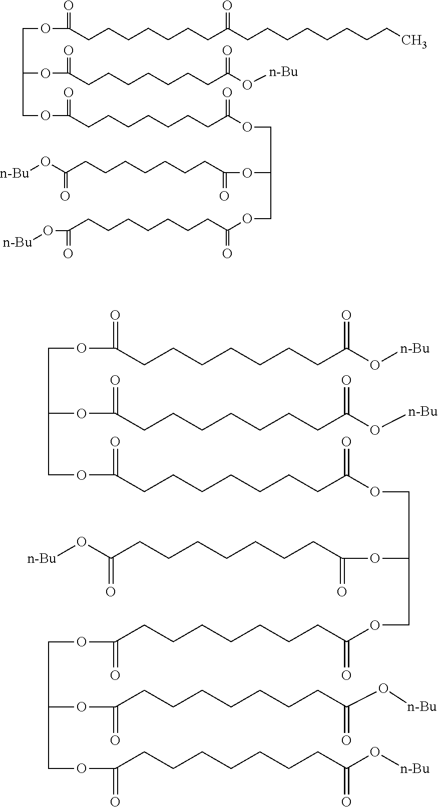

Other examples of oligomer structures according to the invention have R₁=C₇ akylenes, R₄=C₄ alkylenes, n=2 and R₂ and R₃ independently selected from the following groups:
C(O)—(CH₂)₆₋₁₀—COOBu
C(O)—(CH₂)₁₆—COOBu
C(O)—(CH₂)₆₋₁₀—CH₃
C(O)—(CH₂)₁₆—CH₃
C(O)—(CH₂)₈₋₉—CO—(CH₂)₇₋₈—CH₃
C(O)—(CH₂)₆—CO—(CH₂)₇—CH═CH—CH₃.

The vegetable oil derivatives in group A1 according to this invention may contain monomer triglycerides containing at least one C₆-C₂₄ dicarboxylic acid residue. Monomer triglycerides containing two C₆-C₂₄ dicarboxylic acid residues, where the dicarboxylic acids are the same or different, are particularly preferred. Also preferred are monomer triglycerides containing at least one C₆-C₂₄ dicarboxylic acid residue and at least one C₆-C₂₄ monocarboxylic acid residue having at least one ketone group and/or at least one hydroxyl group. The carboxylic acid residues present in the said monomer triglycerides are esterified with straight or branched C₁-C₁₂ monoalcohols.

Preferably, the mixtures of triglycerides (group A1 of vegetable oil derivatives according to this invention) also contain oligo glycerols such as diglycerol and triglycerol and their esters with mono- or dicarboxylic acids. Diglycerol and triglycerol esters comprising one or more C₆-C₂₄ dicarboxylic acids are preferred. Diglycerol and triglycerol esters comprising at least one saturated or unsaturated monocarboxylic acid containing one or more hydroxyl groups and/or a ketone group are also preferred.

The triglyceride mixtures comprising one or more oligomer structures in group A1) of vegetable oils preferably have a Mn of between 800 and 1000 Da, a kinematic viscosity of between 5 and 400 cSt at 100° C. and a glass transition temperature (Tg) of between −85° C. and −40° C., more preferably between −80° C. and −50° C., and even more preferably between −78° C. and −60° C. The number average molecular mass (Mn) is determined by GPC analysis following calibration and polystyrene standards.

Kinematic viscosity is calculated as the ratio between dynamic viscosity (measured by means of a HAAKE VT 500 rotational viscosity meter provided with a MV1 rotor at 100° C.) and density.

The glass transition temperature (Tg) is determined by differential scanning calorimetry with a single run from −100° C. to 30° C. with a rate of temperature rise of 20° C./min.

The said glyceride mixtures have a density which is preferably between 0.90 and 1.05 g/cm³, determined by measuring 100 mL of the said mixtures at 100° C.

Advantageously, the acid number of the mixtures is less than 50, preferably less than 10 and more preferably less than 5 mg KOH/g. By acid number is meant the quantity of KOH expressed in mg which is used to neutralise the acidity of 1 g of substance. The determination is made in accordance with standard ASTM D974-07 in the presence of phenolphthalein.

The degree of unsaturation of the triglyceride mixtures, expressed as the I₂ number and determined by titration according to the Wijs method is preferably between 0 and 140 g I₂/100.

The saponification number of the triglyceride mixtures, understood to be the quantity of KOH expressed in mg consumed in the saponification of 1 gram of substance, is preferably between 150 and 500 mg KOH/g.

The hydroxyl number of the triglyceride mixtures is preferably between 10 and 100 mg KOH/g. It is determined by titration with HCl in the presence of phenolphthalein of the residual KOH after reflux saponification for 60 minutes.

The triglyceride mixtures comprising one or more oligomer structures in group A1) of vegetable oils are insoluble in boiling water. These mixtures are however completely soluble in diethylether, ethyl alcohol, acetone and chloroform at ambient temperature. They are also characterised by high stability to hydrolysis.

The triglyceride mixtures containing one or more oligomer structures (group A1) of vegetable oil derivatives according to the invention may be prepared as described in international patent application entitled “Complex oligomeric structures” (PCT/EP2011/073492), the contents of the said application being incorporated here by reference.

With reference to group A2) of vegetable oil derivatives according to this invention (triglycerides of one or more long chain carboxylic acids comprising at least one carboxylic acid containing vicinal hydroxyl groups), the partial or total oxidation product of the vegetable oils with H₂O₂ is particularly preferred. By way of example, mention is made of the derivatives obtained in accordance with the processes described in patent application WO/2008138892 and MI2009A002360. Sunflower oil derivatives and in particular sunflower oil having a high oleic acid content (HOSO) derivatives are of particular interest.

With reference to group A3) of vegetable oil derivatives according to this invention (polyol esters with at least one C₆-C₂₄ monocarboxylic acid and at least one C₆-C₂₄ dicarboxylic acid, these esters being different from triglycerides), polyols such as neopentylglycol, trimethylolpropane and pentaerythritol or in any event polyols containing primary hydroxyl groups are particularly preferred. Advantageously, the said esters contain monocarboxylic and dicarboxylic acids in ratios of preferably from 2:1 to 10:1. The monocarboxylic acids have C₈-C₂₄ chains; the dicarboxylic acids have C₆-C₂₄ chains.

In addition to vegetable oil derivatives the elastomer compositions may comprise extender oils selected from mineral oils and natural oils. The mineral oils may be of the paraffin, naphthenic or aromatic type and corresponding mixtures. Examples of mineral oils are DAE, TDAE and MES and RAE (Residual Aromatic Extract). By natural oils are meant all oils not derived from petroleum which are of animal origin (for example whale oil and fish oil) and plant origin.

Among the natural oils, particularly preferred are vegetable oils such as for example: peanut oil, Brassicaceae oils, safflower and coconut oils, sunflower oils having various oleic contents, jatropha oils, and linseed, olive, macadamia, mahua, neem, palm, papaver, pongamia, castor, rice, rubber tree seed (Hevea brasiliensis), maize, mustard, sesame and grape seed oils.

Preferably the compositions according to this invention comprise a mixture of extender oils preferably comprising at least 15% by weight with respect to the total content of extender oils of one or more vegetable oil derivatives selected from A1, A2 and A3 derivatives described above. In a particularly preferred embodiment the extender oils of the compositions according to this invention comprise one or more derivatives of vegetable oils selected from the A1, A2 and A3 derivatives described above. More preferably from the A1 derivatives.

As far as the fillers which can be used in compositions according to this invention are concerned, these are preferably selected from kaolin, barytes, clay, talc, calcium and magnesium, iron and lead carbonates, aluminium hydroxide, diatomaceous earth, aluminium sulfate, barium sulfate and biofillers containing starch. Among the biofillers containing starch those preferred are destructured or crosslinked starch as described in patent application no. MI2014A002189 and starch complexed with polymers containing hydrophilic groups intercalated with hydrophobic sequences and mixtures thereof such as for example described in patent EP 1 127 089 and the products marketed by Novamont S.p.A. as MATER-Bi 2030/3040 and MATER-Bi 1128 RR. Preferably, the biofillers comprising starch are present in the compounds according to this invention in quantities of between 1 and 50 phr.

The compositions according to this invention preferably comprise one or more reinforcing fillers advantageously selected from carbon black, mineral fillers such as precipitated silica, inorganic compounds such as activated calcium carbonate or organic compounds such as resins having a high styrene content and phenol-formaldehyde resins.

As far as the carbon black is concerned, this is preferably used in quantities of between 10 and 150 phr, more preferably between 10 and 100 phr, even more preferably between 15 and 80 phr. In a preferred embodiment the carbon black has a specific surface area determined by nitrogen absorption of 40 to 150 m²/g and a DBP (dibutyl phthalate) absorption number of 70 to 180 ml/100 g determined in accordance with ASTM-D-2414. It is preferable that the carbon black should be in the form of small particles provided with a good oil absorption capacity. Even more preferable is a carbon black in which —OH groups have been introduced on the surface, given that these groups are reactive towards any bonding agents present in the composition.

As far as mineral fillers are concerned, these preferably comprise silica. Any type of silica may be used, for example anhydrous silica obtained by precipitation from sodium silicate having dimensions within the range 20-80 nm and a surface area of 35-150 m²/g. The quantity of silica preferably used in the compositions according to this invention will be from 10 to 150 phr, more preferably from 15 to 120 phr.

As far as bonding agents are concerned, these are preferably used in quantities of between 0.1 and 20 phr and are preferably selected from organosilanes, more preferably from trialkoxysilanes and dialkoxysilanes with functional groups. In a preferred embodiment the bonding agent is selected from one or more compounds having a general formula selected from:

(RO)₃SiCₙH₂ₙSₘCₙH₂ₙSi(OR)₃ (I)

(RO)₃SiCₙH₂ₙX (II)

(RO)₃SiCₙH₂ₙSₘY (III)

in which R represents an alkyl group having from 1 to 4 carbon atoms, the three R being the same or different;

“n” represents an integer from 1 to 6,

“m” represents an integer from 1 to 6;

X represents a mercaptan group, an amino group, a vinyl group, a nitroso group, an imide group, a chlorine atom or an epoxy group;

Y represents a cyano group, a N,N-dimethyl thiocarbamoyl group, a mercaptobenzotriazole group or a methacrylate group.

Particularly preferred are organosilanes having at least one sulfur atom, in particular because of their reactivity towards partly hydrogenated rubber during the vulcanisation stage. Even more particularly preferred are organosilanes selected from bis(3-triethoxysilylpropyl)tetrasulfide; γ-mercaptopropyl methoxysilane; 3-thiocyanatopropyl triethoxysilane; trimethoxysilyl propyl mercaptobenzotriazole tetrasulfide. The quantity of bonding agent is preferably within the range 0.1 to 20 phr. In one embodiment of this invention the bonding agents comprising silicon compounds may also be compounds containing silicon which did not react during the preparation of the destructured crosslinked starch according to this invention.

The elastomer compositions according to this invention preferably comprise at least one vulcanising agent. As far as vulcanising agents are concerned, these are selected from sulfur and compounds containing sulfur. Typical compounds containing sulfur are sulfur monochloride, sulfur dichloride, disulfide, polysulfide. Preferably the vulcanising compound comprises sulfur. In compositions according to this invention the quantity of vulcanising agent is preferably between 0.1 and 10 phr. A vulcanisation accelerator, a crosslinking activator and agent may also be used together with the vulcanising agent. Vulcanisation accelerators include derivatives of guanidine, amino-aldehydes, ammonia-aldehydes, thiazole derivatives, sulfene amido compounds, thioureas, thiourams, dithiocarbamates, xanthates.

Typical activators are zinc oxide and stearic acids.

Typical examples of crosslinking agents include oxime derivatives, nitroso derivatives, polyamines, in addition to a free radical initiator such as an organic peroxide and an azo derivative.

As far as the anti-oxidant or anti-ageing agents are concerned, these include amine derivatives such as diphenyl amine and p-phenylene diamine, derivatives of quinoline and hydroquinone, monophenols, diphenols, thiobisphenols, impeded phenols and esters of phosphoric acid.

These compounds and their corresponding mixtures may be used in the range from 0.001 to 10 parts by weight per 100 parts of elastomer material (phr).

The compositions according to this invention comprising at least one elastomer and at least one destructurized crosslinked starch may be prepared by any procedure known to those skilled in the art for the purpose. Preferably the compositions according to this invention can be obtained by mixing at least one elastomer and at least one destructurized crosslinked starch according to the invention, as well as any further component, in the typical items of equipment used for the purpose, for example roller mixers, Banbury internal mixers, extruders, preferably at a temperature comprised between 50° C. and 190° C. and for a time comprised between 4 and 14 minutes.

The compositions according to this invention may be prepared by mixing the components in a single stage or in various steps using methods known in the sector of elastomer compositions. In this latter case a first method comprises mixing first the elastomer components, the destructured crosslinked starch and, if used, the other components apart from any vulcanising agents in a Banbury-type internal mixer. Subsequently the intermediate composition so obtained is mixed with vulcanising agents and accelerators in a roller mixer. In a second method, again in stages, the silica and the bonding agent are first mixed and caused to react and then the product of this reaction is mixed with the elastomers, the destructured crosslinked starch and any other components, apart from any vulcanising agents which are mixed during a subsequent later stage.

In a preferred embodiment of the present invention, the compositions according to the invention are prepared by means of a process comprising the steps of:
a. extruding at least one native starch in the presence of 1-40% by weight with respect to the weight of the native starch of one or more plasticising agents preferably comprising at least 2-90% by weight of glycerol with respect to the total weight of plasticising agents, at a temperature of between 110 and 250° C., preferably 130-180° C.,
b. causing the starch and the extruded plasticisers in stage a to react, preferably under the same conditions as in stage a, with 0.1-5% by weight with respect to the weight of the starch of at least one crosslinking agent, preferably glyoxal;
c. mixing at least one elastomer and at least one destructured crosslinked starch obtained in step b., as well as any further component, at a temperature preferably comprised between 50° C. and 190° C. and for a time preferably comprised between 4 and 14 minutes.

The elastomer composition according to the invention may be subsequently mixed, shaped and vulcanised in accordance with known methods. This invention also relates to the elastomer compositions formed and/or vulcanised which can be obtained from compositions according to this invention.

The invention will now be described with some examples which are intended to be illustrative without limiting it.

### EXAMPLES

Methods Used for Characterisation

Karl-Fischer Titration

Karl-Fischer titration (in pyridine) was carried out using a KF Metrohm Titroprocessor 686 titration device controlled by the Dosimat 665 device. The Karl-Fischer reagent was titrated (correction factor) using sodium tartrate dissolved in methanol.

The solvent in which the samples were dispersed (N,N-dimethylformamide in molecular sieves—H₂O<0.01% m/m) was titrated to obtain the blank value, which had to be subtracted from the sample measurements.

The water content of the samples was measured by weighing approximately 1 g of sample in a 27 ml bottle to which were added 20 ml of N,N-dimethylformamide, together with a magnetic stirrer. The bottle was hermetically sealed and heated with gentle stirring to 80° C. on a magnetic plate until the sample had completely disaggregated (approximately 1 hour's mixing). The bottle was then left to cool to ambient temperature. 10 ml of the dispersion in N,N-dimethylformamide were then placed in the titrator cell together with 30 ml of pyridine in order to carry out the titration.

The water content of the sample was expressed as a percentage, having regard to the volume of Karl-Fischer reagent used with the sample (subtracted from that of the blank), the Karl-Fischer reagent correction factor and the mass of sample used for the measurement.

HPLC Analysis

The HPLC analysis was carried out using a Thermo Scientific Accela instrument provided with a refractive index detector and fitted with a Phenomenex Rezex ROA H+ column. An aqueous solution of 0.005 N of sulfuric acid was used as the eluent. The analyses were carried out at 65° C. with a flow of 0.6 ml/min.

Calibration curves for glycerine and citric acid were produced under the conditions described above using glycerine and citric acid solutions at different concentrations to calculate the instrument response factor.

In order to measure the citric acid and glycerine content a quantity of approximately 500 mg of sample was weighed and placed in a 100 ml flask containing 25 ml of distilled water for 24 hours at ambient temperature in order to extract the citric acid and the glycerine from the sample. A quantity of 20 μl of this solution was then injected into the system in order to carry out the HPLC analysis. The glycerine or citric acid contents were expressed as m/m percentages.

Phase Contrast Microscopy

Phase contrast optical microscopy was carried out using a Leitz Wetzlar Orthoplan optical microscope with a magnification (Polaroid 545) of ×400 with a Phaco 2 EF 40/0.65 objective lens, polarising filter no. 5.

Approximately 20 mg of sample were placed on an optical microscope slide together with a drop of distilled water. Using a spatula the sample was homogenised with the water until a slightly viscous paste was obtained. A spatula tip of this paste was placed between two optical microscopy slides and gently slid so as to obtain a semi-transparent film which was subsequently analysed.

SEM Microscopy

Vulcanised rubber specimens were broken up at ambient temperature, metallised with gold and observed using a FE-SEM ZEISS Supra 40 electron microscope at low magnifications (×200-800 with respect to the Polaroid 545) with secondary electrons at an acceleration potential of 10 kV and a working distance of approximately 8 mm.

Mechanical Properties

The vulcanised test specimens were characterised using an Instron 4502 dynamometer equipped with long field extensimeters. The tensile properties were determined in accordance with standard ASTM D412 (type C dumbbell). The fatigue tests were carried out using an Instron 4502 dynamometer equipped with a 100 N load cell on type C ASTM D412 test specimens. The tests were carried out by applying a traversing speed of 250 mm/min with elongations of 10% and 50%.

The rebound tests were carried out using a Schob type pendulum in accordance with standard ASTM D7121.

### Example 1—Preparation of Destructured Crosslinked Starch from Native Starch Preparation of Destructured Starch

A mixture comprising 80.3 parts by weight of native maize starch (C*GEL 03401, 12% of water), 14.4 parts of glycerol, 3.5 parts of an aqueous solution of glyoxal (40% m/m), and 1.8 parts of citric acid was fed to a dual screw extruder (diameter=21 mm, L/D=40) operating under the following conditions:
rpm (min⁻¹)=100;
temperature profile (° C.): 60-80-140-170-160-140-110-90;
throughput (kg/h): 2.5;
degassing: closed;
Head temperature (° C.): 91;
Head pressure (bar): 13-17.

The destructured starch obtained in this way was analysed by phase contrast optical microscopy as previously described in the “Phase contrast microscopy” section and demonstrated that structures which could be related to the native granular structure of the starch were completely absent.

The destructured crosslinked starch also underwent compositional analysis, being characterised by means of Karl-Fischer titration and HPLC analysis (Table 1).

TABLE 1
Composition analysis of destructured and crosslinked starch

| | destructured starch |
|---|---|
| | (% by weight) |
| Starch | 75.5 |
| Glycerol | 11.3 |
| Water | 9.4 |
| Citric acid | 2.3 |
| Glyoxal | 1.5 |

### Examples 2-6

The destructured crosslinked starch according to Example 1 and a commercial complexed starch-based biofiller were used to prepare the compositions in Examples 2-6 respectively shown in Table 2.

TABLE 2
Compositions of Examples 2-6

| | | Example 3 | Example 4 | | |
|---|---|---|---|---|---|
| | Example 2 | (comparative) | (comparative) | Example 5 | Example 6 |
| | phr | phr | phr | phr | phr |
| SBR rubber¹ | 100 | 100 | 100 | 100 | 100 |
| Destructured crosslinked | 9.6 | — | 2 | 3.8 | 7.5 |
| starch (Example 1) | | | | | |
| Biofiller² | — | 9.6 | — | — | — |
| Silica³ | 54 | 54 | 67.1 | 64.5 | 59 |
| Silane⁴ | 5.80 | 5.80 | 5.70 | 5.75 | 5.90 |
| Stearic acid | 1.5 | 1.5 | 1.5 | 1.5 | 1.5 |
| Extender oil⁵ | 17 | 17 | 17 | 17 | 17 |
| Antidegradation agent⁶ | 1.5 | 1.5 | 1.5 | 1.5 | 1.5 |
| ZnO | 2.6 | 2.6 | 2.6 | 2.6 | 2.6 |
| Sulfur | 1 | 1 | 1.0 | 1.0 | 1.0 |
| Vulcanising agent 1⁷ | 1.3 | 1.3 | 1.3 | 1.3 | 1.3 |
| Vulcanising agent 2⁸ | 1.5 | 1.5 | 1.5 | 1.5 | 1.5 |

¹SBR1502 (Versalis Europrene),
²Mater-Bi 1128RR (starch complexed with poly(ethylenevinyl alcohol), produced by Novamont S.p.A.),
³Zeosil 1165 MP (Rhodia),
⁴Si-69 (Evonik),
⁵TDAE (Repsol Extensoil),
⁶Vulkanox HS/LG (Lanxess),
⁷Vulkacite DM/MG (Lanxess),
⁸Vulcacite D-EG/C (Lanxess)

The compositions in Examples 2-6 were prepared and vulcanised in accordance with the following method.

SBR rubber was loaded into a 300 cm³ Banbury Pomini Farrel mixer and mixed at 80 rpm for 30 seconds at T=133° C. The quantities of SBR rubber and the other components used were selected so as to obtain a final volume filling the mixer chamber to 86%. The silica and the extender oil were added to the SBR rubber in three equal aliquots, mixing the system for 30 seconds between one addition and the next. The silane was added together with the second aliquot of silica and extender oil, while the other components (apart from the vulcanising agents) were added together with the third aliquot of silica and extender oil. The mixture was then further mixed until a chamber temperature of 160° C. was reached. Once this temperature had been reached stirring was reduced to 60 rpm and mixing continued under these conditions for a further two minutes.

The mixture so obtained was discharged and underwent a further stage of mixing (known as remill) in the 300 cm³ Banbury Pomini Farrel mixer set to 140° C., 80 rpm (chamber filling volume 86%). The mixture was allowed to mix for the time necessary to reach 160° C. and then again discharged. The purpose of the remill operation is to ensure a uniform distribution of all the components in the volume of the mixture.

The mixture finally underwent vulcanisation. The mixture was again loaded into the 300 cm³ Banbury Pomini Farrel mixer (chamber filling volume 86%) and mixed at 70° C., 60 rpm for 30 seconds. The vulcanising agents were then added and after two minutes of further mixing, the mixture together with the vulcanising agents was discharged and vulcanised at 160° C. for 30 minutes.

The vulcanised composition so obtained was then mechanically characterised (Table 4).

TABLE 4
Mechanical characterisation of the compositions according to Examples 2 and 3
(comparative)

| | | | | | | 10% | | 50% | |
|---|---|---|---|---|---|---|---|---|---|
| | | | | | | deformation | | deformation | |
| | | | | | | hysteresis | | hysteresis | |
| | σ_{b} | ε_{b} | E₁₀₀ | E₂₀₀ | Rebound | (mJ) | | (mJ) | |
| Examples | (MPa) | (%) | (MPa) | (MPa) | (%) | cycle I | cycle V | cycle I | cycle V |
| 2 | 16.6 | 276 | 4.0 | 5.0 | 51.9 | 1.5 | 1.1 | 35.6 | 18.4 |
| 3 (comp.) | 18.6 | 314 | 3.3 | 4.6 | 49.6 | 1.9 | 1.2 | 44.5 | 22.3 |
| 4 (comp.) | 18.8 | 360 | 2.7 | 3.5 | 45.0 | 2.6 | 1.8 | 50.5 | 27.1 |
| 5 | 18.9 | 351 | 2.9 | 3.9 | 45.3 | 2.4 | 1.6 | 49.8 | 25.8 |
| 6 | 15.8 | 324 | 2.8 | 3.7 | 46.8 | 2.1 | 1.4 | 43.6 | 23.7 |

As will be seen, the composition according to the invention in Example 2 demonstrates σ_{b}, ε_{b}, E₁₀₀, E₂₀₀, and Rebound mechanical properties which are substantially equivalent to those of comparative Example 3, and further shows improved hysteresis properties, as will be seen from the lower dissipated energy values (in mJ) in both deformation-recovery stress cycles I and V. Comparative Example 4, furthermore, shows the hysteresis reducing effect of the additive according to the invention is significantly lower below 3 phr.

1. An elastomeric composition comprising a destructurized and crosslinked starch uniformly dispersed in said elastomeric composition in an effective amount as a hysteresis reduction additive in said elastomeric composition.

2. The elastomeric composition according to claim 1, in which said destructurized and crosslinked starch is added in an amount of from 3 to 70 parts per 100 parts of elastomer (phr) in said elastomeric composition.

3. The elastomeric composition according to claim 1, in which said destructurized and crosslinked starch is obtainable by means of a process in which the starch is destructurized and at the same time mixed with at least one crosslinking agent.

4. The elastomeric composition according to claim 1, in which said destructurized and crosslinked starch is obtainable by means of a process in which the starch is first destructurized and then mixed with at least one crosslinking agent.

5. The elastomeric composition according to claim 1, in which said destructurized and crosslinked starch comprises 1-40% by weight, with respect to the weight of starch, of one or more plasticisers selected from the group consisting of water and polyols having from 2 to 22 carbon atoms.

6. The elastomeric composition claim 1, in which said destructurized and crosslinked starch comprises 0.1-5% by weight, with respect to the weight of starch, of one or more of depolymerizing agents selected from the group consisting of organic acids, inorganic acids, and enzymes.

7. The elastomeric composition according to any one of claims from 1 to 6 claim 1, in which said destructurized and crosslinked starch comprises 0.1-5% by weight with respect to the weight of starch, of one or more crosslinking agents.

8. The elastomeric composition according to claim 7, in which said crosslinking agent is selected from the group consisting of aldehydes, polyaldehydes and anhydrides.

9. The elastomeric composition according to claim 8, in which said crosslinking agent is glyoxal.

10. A composition comprising:
i. at least one elastomer;
ii. 3-70 phr of a destructurized and crosslinked starch as hysteresis reduction additive.

11. The composition according to claim 10, in which said elastomer is selected from the group consisting of natural rubbers and synthetic rubbers.

12. The composition according to claim 11, in which said synthetic rubbers are selected from the group consisting of dienic homopolymers, block copolymers styrene-butadiene-styrene, random copolymers styrene-isoprene, block copolymers styrene-isoprene-styrene, block copolymers acrylonitrile-butadiene, random copolymers vinylarene-conjugated diene.

13. The elastomeric composition according to claim 2, in which said destructurized and crosslinked starch is obtainable by means of a process in which the starch is destructurized and at the same time mixed with at least one crosslinking agent.

14. The elastomeric composition according to claim 2, in which said destructurized and crosslinked starch is obtainable by means of a process in which the starch is first destructurized and then mixed with at least one crosslinking agent.

15. The elastomeric composition according to claim 2, in which said destructurized and crosslinked starch comprises 1-40% by weight, with respect to the weight of starch, of one or more plasticisers selected from the group consisting of water and polyols having from 2 to 22 carbon atoms.

16. The elastomeric composition according to claim 3, in which said destructurized and crosslinked starch comprises 1-40% by weight, with respect to the weight of starch, of one or more plasticisers selected from the group consisting of water and polyols having from 2 to 22 carbon atoms.

17. The elastomeric composition according to claim 4, in which said destructurized and crosslinked starch comprises 1-40% by weight, with respect to the weight of starch, of one or more plasticisers selected from the group consisting of water and polyols having from 2 to 22 carbon atoms.

18. The elastomeric composition according to claim 2, in which said destructurized and crosslinked starch comprises 0.1-5% by weight, with respect to the weight of starch, of one or more of depolymerizing agents selected from the group consisting of organic acids, inorganic acids, and enzymes.

19. The elastomeric composition according to claim 3, in which said destructurized and crosslinked starch comprises 0.1-5% by weight, with respect to the weight of starch, of one or more of depolymerizing agents selected from the group consisting of organic acids, inorganic acids, and enzymes.

20. The elastomeric composition according to claim 4, in which said destructurized and crosslinked starch comprises 0.1-5% by weight, with respect to the weight of starch, of one or more of depolymerizing agents selected from the group consisting of organic acids, inorganic acids, and enzymes.
